(19) United States
(12) Patent Application Publication
(10) Pub. No.: US 2012/0034817 A1
(43) Pub. Date: Feb. 9, 2012

(54) Shielded Plug-In Connector Arrangement

(75) Inventors: Herbert Plate, Luedenscheid (DE); Joerg Hegel, Hagen (DE)

(73) Assignee: KOSTAL KONTAKT SYSTEME GMBH, Luedenscheid (DE)

(21) Appl. No.: 13/251,592

(22) Filed: Oct. 3, 2011

Related U.S. Application Data
(63) Continuation of application No. PCT/EP2010/054227, filed on Mar. 30, 2010.

(30) Foreign Application Priority Data
Apr. 3, 2009 (DE) 10 2009 016 157.0

(51) Int. Cl. H01R 9/05

(52) U.S. Cl. 439/578

(57) ABSTRACT

A cable assembly includes a coaxial cable and a plug-and-socket (plug-in) connector part. The connector part has a sleeve, a sleeve contact, and a shielding module. The sleeve is connected to the outer conductor of the cable at a free end section of the cable and the sleeve contact is connected to the inner conductor of the cable. The shielding module includes a shielding plate and a chamber insert. The chamber insert is inserted into the shielding plate and receives the sleeve contact. The shielding module is connected to the sleeve such that the sleeve and the shielding plate surround the sleeve contact with the sleeve contact enclosed by the chamber insert up to a side of the sleeve contact intended for connecting along a direction of insertion with a contact pin of a mating plug-in connector.

### CROSS-REFERENCE TO RELATED APPLICATIONS

This application is a continuation of International Application No. PCT/EP2010/054227, published in German, with an international filing date of Mar. 30, 2010, which claims priority to DE 10 2009 016 157.0, filed Apr. 3, 2009; the disclosures of which are incorporated by reference.

### TECHNICAL FIELD

The present invention relates to a shielded plug-and-socket connector arrangement having a plug-and-socket connector part that includes a sleeve and a push-on sleeve contact in which the sleeve can be connected electrically with the outer conductor of a coaxial cable and the sleeve contact that can be connected electrically with the inner conductor of the coaxial cable.

### BACKGROUND

Plug-and-socket connectors that are connected to a shielded coaxial cable often have sleeve-shaped components for contacting the outer conductor (i.e., line shield) of a coaxial cable. Such connectors are known, for example, from DE 697 01 065 T2 and DAS 1 156 467.

DE 10 2004 015 345 A1 (corresponding to U.S. Pat. No. 7,241,189) describes a push-on sleeve contact that can be contacted by a contact pin. The sleeve contact is usable for high-voltage or high-current applications. This document does not describe how a completely shielded and touch-proof plug-and-socket connector assembly can be built with such a sleeve contact. This document describes a simple and cost-effective plug contact assembly with a push-on sleeve contact that features a touch-proof design and relatively good electrical shielding.

### SUMMARY

An embodiment of the present invention provides a cable assembly. The cable assembly includes a coaxial cable and a plug-and-socket connector part (i.e., a plug-in connector part). The coaxial cable has inner and outer conductors. The plug-in connector part has a sleeve, a sleeve contact, and a shielding module. The sleeve is connected to the outer conductor of the coaxial cable at a free end section of the coaxial cable and the sleeve contact is connected to the inner conductor of the coaxial cable. The shielding module includes a shielding plate and a chamber insert. The chamber insert is inserted into the shielding plate and is configured to receive the sleeve contact. The shielding module is connected to the sleeve with a portion of the shielding plate being received by the sleeve such that the sleeve and the shielding plate surround the sleeve contact with the sleeve contact being enclosed by the chamber insert up to a side of the sleeve contact intended for connecting along a given direction of insertion with a contact pin of a mating plug-in connector. The chamber insert electrically insulates the sleeve contact from the sleeve and the shielding module.

Another embodiment of the present invention provides a plug-in connector. The plug-in connector includes a sleeve, a sleeve contact, and a shielding module. The sleeve is connectable to an outer conductor of the coaxial cable at a free end section of the coaxial cable. The sleeve contact is connectable to an inner conductor of the coaxial cable. The shielding module has a shielding plate and a chamber insert. The shielding module is inserted into the sleeve, the chamber insert is inserted into the shielding plate, and the sleeve contact is inserted into the chamber insert such that the sleeve and the shielding plate surround the sleeve contact with the sleeve contact being enclosed by the chamber insert up to a side of the sleeve contact intended for connecting along a given direction of insertion with a contact pin of a mating plug-in connector. The chamber insert electrically insulates the sleeve contact from the sleeve and the shielding plate.

Embodiments of the present invention are directed to a shielded plug-in connector arrangement having a first plug-and-socket connector part (i.e., a first plug-in connector part). The connector part has a sleeve, a push-on sleeve contact (i.e., a pin bushing contact), and an insulating chamber insert. The connector part may further include a shielding plate. The shielding plate is attachable to the sleeve. The sleeve is connected to the outer conductor (i.e., line shield) of a coaxial cable. The sleeve contact is connected to the inner conductor of the coaxial cable. The sleeve, or the sleeve together with the attached shielding plate, encloses the sleeve contact on all sides except the side of the intended plugging direction. The chamber insert surrounds the sleeve contact and electrically insulates the sleeve contact from the sleeve and from the shielding plate if present.

In an embodiment of the present invention, the metal walls of the sleeve enclose as much as possible the push-on sleeve contact. The metal walls of the shielding plate aid the enclosure of the sleeve contact when the shielding plate is connected to the sleeve. As a result, the sleeve contact is only accessible in the intended direction of insertion for contacting by a mating plug-and-socket connector.

In an embodiment of the present invention, the shielding plate is connected to the sleeve and thereby enables the creation of a well shielded plug-and-socket connector arrangement in a simple manner. This plug-and-socket connector arrangement has a direction of insertion that is perpendicular to the coaxial cable connection direction.

In an embodiment of the present invention, the insulating chamber insert has a form that matches the contours of the push-on sleeve contact, the sleeve, and the shielding plate. The chamber insert stabilizes the position of the sleeve contact inside the sleeve and the shielding plate. As such, the chamber insert surrounds the sleeve contact and insulates the sleeve contact from the walls of the sleeve and the shielding plate. The chamber insert encapsulates the sleeve contact as completely as possible up to an opening for a mating plug-and-socket connector to contact the sleeve contact.

The above features, and other features and advantages of the present invention are readily apparent from the following detailed description thereof when taken in connection with the accompanying drawings.

### BRIEF DESCRIPTION OF THE DRAWINGS

FIGS. 1 through 6 illustrate various views of a cable assembly in accordance with an embodiment of the present invention;

FIGS. 7 through 9 illustrate various views of a cable assembly in accordance with another embodiment of the present invention; and

FIGS. 10 and 11 illustrate various views of a cable assembly in accordance with another embodiment of the present invention.

### DETAILED DESCRIPTION

Detailed embodiments of the present invention are disclosed herein; however, it is to be understood that the disclosed embodiments are merely exemplary of the present invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

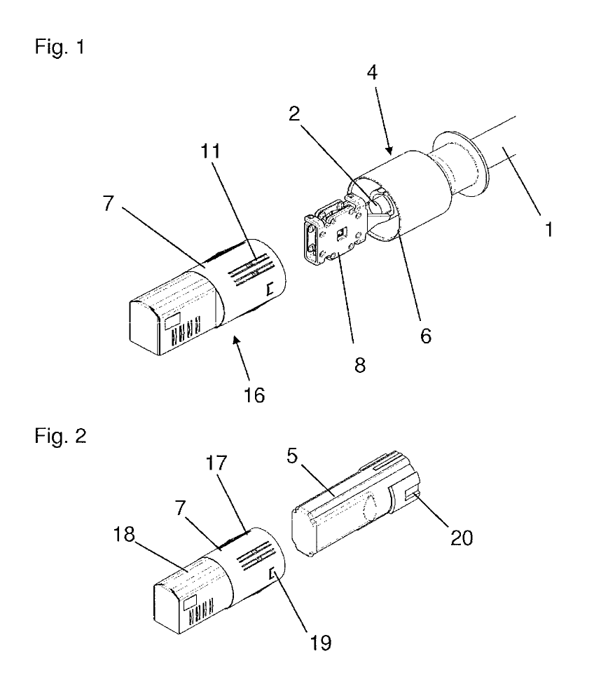

Referring now to FIG. 1 through FIG. 6, a cable assembly in accordance with an embodiment of the present invention will be described. The cable assembly includes a shielded coaxial cable 1 and a first plug-and-socket connector part 9 (i.e., a plug-in connector part). Connector part 9 is connectable to a free end section of coaxial cable 1.

Coaxial cable 1 includes an inner electrical conductor 2 and an outer electrical conductor. The conductors run along the length of coaxial cable 1 and are radially separated from one another. The outer conductor is a braided metal. Coaxial cable 1 further includes an insulation layer. The insulation layer runs between the conductors along the length of coaxial cable 1.

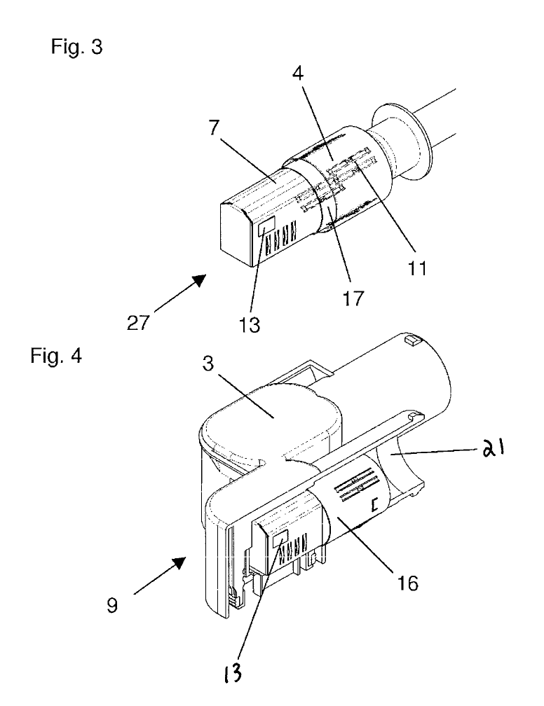

Connector part 9 includes a sleeve 4 and a push-on sleeve contact 8. As shown, for example in FIG. 3, connector part 9 connects to the free end section of coaxial cable 1. To this end, sleeve 4 is connected to the outer conductor of coaxial cable 1. Sleeve 4 opens in the direction of the free end section of coaxial cable 1 and surrounds the free end section. Sleeve 4 is made of metal. As indicated above, sleeve 4 contacts the outer conductor (i.e., the metallic shield) of coaxial cable 1. Inner conductor 2 of coaxial cable 1 is configured to be connected with sleeve contact 8. In FIG. 1, sleeve contact 8 is crimped to inner conductor 2. Sleeve 4 surrounds the connection point between inner conductor 2 and sleeve contact 8. Sleeve contact 8 is illustrated as an exemplary socket that can be contacted by a flat pin contact of a mating plug-and-socket connector from various insertion directions.

Connector part 9 further includes a shielding module 16. Shielding module 16 is provided for electromagnetic shielding and for insulating sleeve contact 8. Shielding module 16 includes a shielding plate 7 and a chamber insert 5. Shielding plate 7 is formed integrally from a metal strip. Chamber insert 5 is made from an insulating plastic material.

Shielding plate 7 of shielding module 16 has a cylinder-shaped section 17 and a box-shaped section 18. Chamber insert 5 of shielding module 16 is matched to the shape of shielding plate 7. As such, chamber insert 5 may completely insert into the interior of shielding plate 7. The outer walls of chamber insert 5 lie against the inner walls of shielding plate 7 when chamber insert 5 is inserted into shielding plate 7. Chamber insert 5 is formed as a hollow body and thereby creates an insulating cladding on the inner walls of shielding plate 7. Chamber insert 5 concurrently stabilizes the walls of shielding plate 7 when chamber insert 5 is inserted into shielding plate 7. Shielding plate 7 is only visible from the outside when shielding module 16 is assembled as chamber insert 5 is completely contained by shielding plate 7.

Shielding plate 7 includes one or more latching elements such as an inwardly directed elastic tab 19 integrally formed thereon. Chamber insert 5 includes a corresponding undercut 20. Tab 19 reaches behind undercut 20 when chamber insert 5 is inserted into shielding plate 7 in order to securely hold chamber insert 5 and shielding plate 7 together.

Shielding module 16 connects to sleeve 4 as shown, for example, in FIG. 3. In particular, cylinder-shaped section 17 of shielding plate 7 of shielding module 16 inserts into hollow cylinder 6 of sleeve 4. This is how the assembly illustrated in FIG. 3 is implemented and will be designated as a push-on sleeve module 27. A relatively stable mechanical and electrical connection is thus achieved between shielding plate 7 and sleeve 4. This insures that contact sections 11, which are integrally formed on cylinder-shaped section 17 of shielding plate 7 and are spring-loaded radially outward, lie against the inner wall of hollow cylinder 6 of sleeve 4.

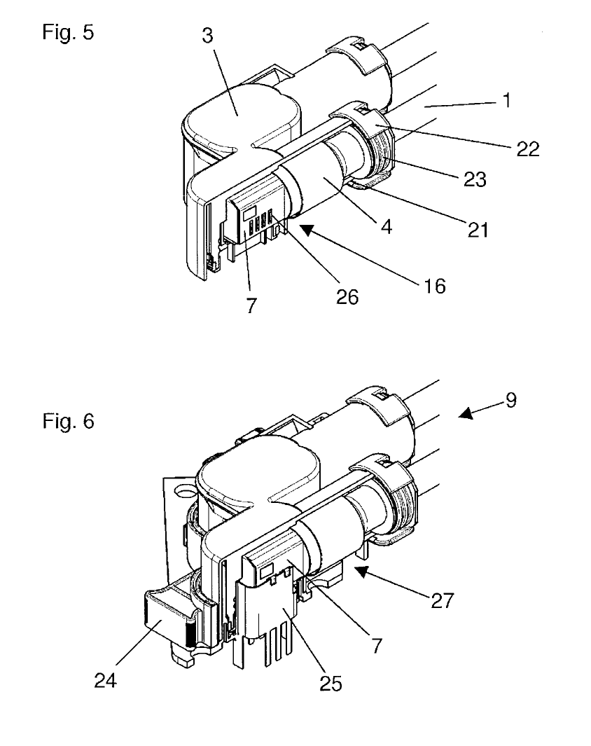

In order to finalize connector part 9, push-on sleeve module 27 is inserted into an insulated push-on sleeve housing 3 as shown, for example, in FIG. 4. Sleeve housing 3 has a chamber 21 configured to receive push-on sleeve module 27. In FIG. 4, shielding module 16 of push-on sleeve module 27 is inserted into chamber 21. In FIGS. 5 and 6, the complete push-on sleeve module 27 is inserted into chamber 21.

For the assembly process, shielding module 16 is initially inserted into chamber 21 of sleeve housing 3. Latching elements 13 integrally formed on shielding plate 7 fix shielding module 16 inside chamber 21. Coaxial cable 1 with connected sleeve 4 and push-on sleeve contact 8 is then introduced into chamber 21 and is thereby connected with shielding module 16 as described.

As illustrated in FIG. 5, a latching clip 22 is latched with push-on sleeve housing 3. Latching clip 22 overlaps coaxial cable 1 and completes chamber 21. A rubber gasket 23 is inserted between latching clip 22 and sleeve housing 3 to make chamber 21 moisture-free. Rubber gasket 23 holds latching clip 22 to sleeve housing 3 by elastic tension so that latching clip 22 cannot be unintentionally loosened.

In FIG. 6, connector part 9 is connected to a second plug-and-socket connector part (i.e., a second plug-in connector part). The second connector part is depicted by a plug housing 24 (shown in a sectional view) and a shielding crown 25. Plug housing 24 has a contact pin as the mating plug-and-socket connector for sleeve contact 8 of first connector part 9. The contact pin cannot be seen in FIG. 6 since it is enclosed by shielding crown 25. Shielding crown 25 is connected mechanically and electrically with shielding plate 7 of push-on sleeve module 27. Integrally molded contact springs 26 on shielding plate 7, which can be seen in FIG. 5, ensure a proper electrical connection to shielding crown 25. A gap-free screening of the plug-and-socket connector is thereby produced by sleeve 4, shielding plate 7, and shielding crown 25.

By way of chamber insert 5, introduced into shielding plate 7, separation of the potential of inner conductor 2 and the outer conductor of coaxial cable 1 is assured. This is because chamber insert 5 can inhibit both a touching contact between sleeve contact 8 and shielding plate 7 and a spark jumping between these components. For this reason, the plug-and-socket connector arrangement is well suited for connecting electric conductors carrying high voltages.

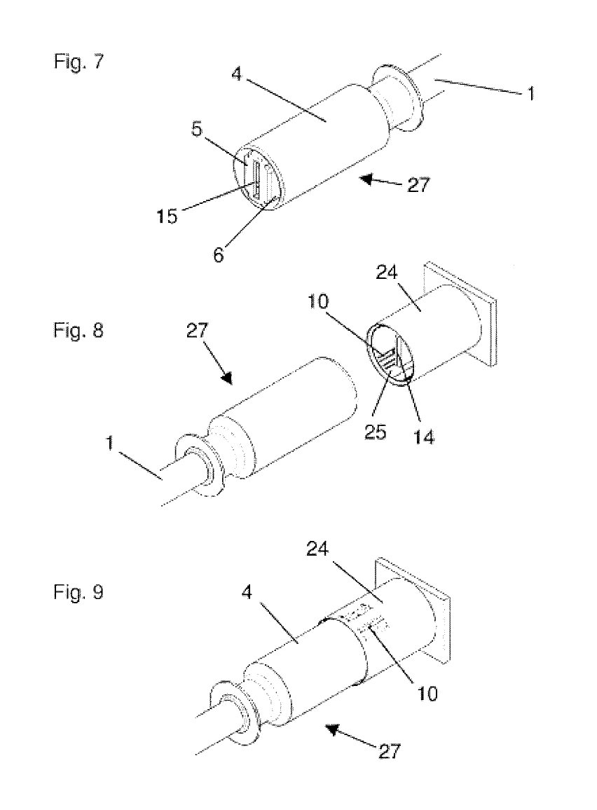

FIGS. 7, 8, and 9 and FIGS. 10 and 11 respectively illustrate a cable assembly in accordance with two other embodiments of the present invention. The direction of insertion of the embodiment described with respect to FIGS. 1 through 6 lies perpendicular to the length of coaxial cable 1. In contrast, in the two additional embodiments, the direction of insertion in the plug-and-socket connector arrangement lies parallel with the direction of coaxial cable 1. As such, the plug-and-socket connector arrangements in accordance with the two additional embodiments of the present invention are even more simply designed than the initial embodiment described above. The same parts or those of comparable functionality make use of the same reference numbers previously identified.

In FIG. 7, sleeve 4 of push-on sleeve module 27 of first connector part 9 is a metallic cylinder having a completely closed surface shell. Sleeve 4 is connected to the outer conductor of coaxial cable 1 in an electrically conducting manner. Sleeve 4 forms hollow cylinder 6 on the side of its free end section. Analogous to the design shown in FIGS. 1 through 6, a push-on sleeve contact connects the inner conductor of coaxial cable 1 within the interior of hollow cylinder 6. In contrast to the design shown in FIGS. 1 through 6, sleeve 4 extends completely over the sleeve contact. Only the part of the sleeve contact provided for accepting a flat contact pin of a mating plug-and-socket connector remains free on the front surface of sleeve 4. This enables an almost complete screening of the sleeve contact to be achieved by sleeve 4. The sleeve contact is mechanically fixed inside sleeve 4. A chamber insert 5 is inserted into hollow cylinder 6 of sleeve 4 and surrounds the sleeve contact on all sides and thereby electrically insulates the sleeve contact from sleeve 4. Chamber insert 5 leaves a gap 15 for receiving the flat contact pin.

In FIG. 8, the second plug-and-socket connector part includes a cylindrical plug housing 24. A contact pin 14 is located within plug housing 24. A sheet metal strip fits around contact pin 14 on the inner walls of plug housing 24 and forms a shielding crown 25. When push-on sleeve module 27 is connected with plug housing 24 as shown in FIG. 9, shielding crown 25 is added to sleeve 4 so that continuous shielding results over the entire length of the plug-and-socket connector. Spring-loaded contact sections 10 are integrally formed on shielding crown 25 in order to obtain a relatively good conducting electrical connection between sleeve 4 and shielding crown 25.

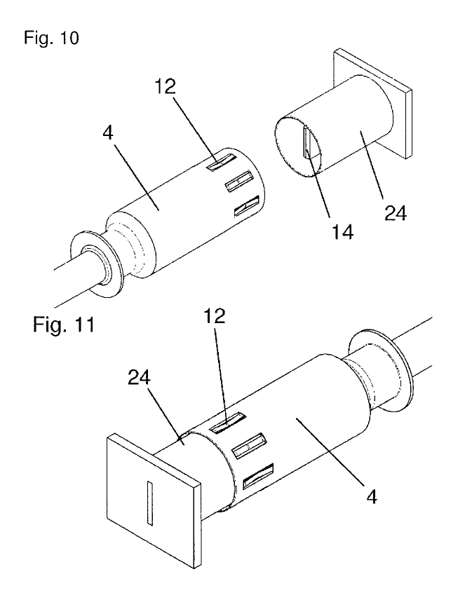

Alternatively, as shown in FIG. 10, spring-loaded contact sections 12 can be integrally formed on sleeve 4. If the associated plug housing 24 is made of metal, then a shielding crown can be eliminated. In FIG. 11, the assembled plug-and-socket connector arrangement is shown. If sleeve 4 is long enough, then sleeve 4 can be shoved far along plug housing 24 so that sleeve 4 almost completely overlaps plug housing 24. Even for plug housing 24 made of plastic, this results in relatively good electrical shielding of the plug-and-socket connector only by the shielding effect of sleeve 4 and shielding crown 25. In this case, only spring-loaded contact sections 12 act to produce the elastic attachment of sleeve 4 to plug housing 24.

### LIST OF REFERENCE NUMBERS

1 coaxial cable
2 inner conductor
3 push-on sleeve housing
4 sleeve
5 chamber insert
6 hollow cylinder
7 shielding plate
8 push-on sleeve contact
9 first plug-and-socket connector part
10 contact sections
11 contact sections
12 contact sections
13 latching element
14 contact pin
15 gap
16 shielding module
17 cylindrical section
18 box-shaped section
19 spring tab
20 undercut
21 chamber
22 latching clip
23 rubber gasket
24 push-on sleeve housing (second plug-and-socket connector part)
25 shielding crown (metal enclosure)
26 contact spring
27 push-on sleeve module

While exemplary embodiments are described above, it is not intended that these embodiments describe all possible forms of the present invention. Rather, the words used in the specification are words of description rather than limitation, and it is understood that various changes may be made without departing from the spirit and scope of the invention. Additionally, the features of various implementing embodiments may be combined to form further embodiments of the present invention.

What is claimed is:

1. A cable assembly comprising:
a coaxial cable having inner and outer conductors; and
a plug-in connector part having a sleeve, a sleeve contact, and a shielding module, wherein the sleeve is connected to the outer conductor of the coaxial cable at a free end section of the coaxial cable and the sleeve contact is connected to the inner conductor of the coaxial cable;
wherein the shielding module includes a shielding plate and a chamber insert, wherein the chamber insert is inserted into the shielding plate and receives the sleeve contact;
wherein the shielding module is connected to the sleeve with a portion of the shielding plate being received by the sleeve such that the sleeve and the shielding plate surround the sleeve contact with the sleeve contact being enclosed by the chamber insert up to a side of the sleeve contact intended for connecting along a given direction of insertion with a contact pin of a mating plug-in connector, wherein the chamber insert electrically insulates the sleeve contact from the sleeve and the shielding module.

2. The assembly of claim 1 further comprising:
a second plug-in connector part having a contact pin that can be connected to the sleeve contact of the first connector part.

3. The assembly of claim 2 wherein:
the second connector part includes a metal enclosure which surrounds the contact pin, wherein the metal enclosure connects to at least one of the sleeve and the shielding module when the connector parts are brought together.

4. The assembly of claim 1 wherein:
the sleeve forms an open cylinder in the direction of the free end section of the coaxial cable;
wherein the shielding plate includes a cylinder-shaped section and a box-shaped section, wherein the portion of the shielding plate received by the sleeve is the cylinder-shaped section;
wherein the cylinder-shaped section is received by the open cylinder of the sleeve to connect the shielding module with the sleeve.

5. The assembly of claim 1 wherein:
the outer conductor of the coaxial cable is a metal mesh.

6. The assembly of claim 1 further comprising:
a push-on sleeve housing having a chamber;
wherein the free end section of the coaxial cable including the shielding module are received in the chamber of the push-on sleeve housing.

7. A plug-in connector comprising:
a sleeve connectable to an outer conductor of the coaxial cable at a free end section of the coaxial cable;
a sleeve contact connectable to an inner conductor of the coaxial cable; and
a shielding module having a shielding plate and a chamber insert;
wherein the shielding module is inserted into the sleeve, the chamber insert is inserted into the shielding plate, and the sleeve contact is inserted into the chamber insert such that the sleeve and the shielding plate surround the sleeve contact with the sleeve contact being enclosed by the chamber insert up to a side of the sleeve contact intended for connecting along a given direction of insertion with a contact pin of a mating plug-in connector, wherein the chamber insert electrically insulates the sleeve contact from the sleeve and the shielding plate.

8. The connector of claim 7 wherein:
the sleeve forms an open cylinder in the direction of the free end section of the coaxial cable;
wherein the shielding plate includes a cylinder-shaped section and a box-shaped section, wherein the cylinder-shaped section of the shielding plate is inserted into the open cylinder of the sleeve such that the shielding module is inserted into the sleeve.

9. The connector of claim 7 further comprising:
a push-on sleeve housing having a chamber;
wherein the shielding module, the sleeve contact, and the sleeve are received in the chamber of the push-on sleeve housing.
